(19) United States
(12) Patent Application Publication
(10) Pub. No.: US 2012/0328134 A1
(43) Pub. Date: Dec. 27, 2012

(54) PERSONAL AUDIO EQUIPMENT

(76) Inventor: Marcus Lewis, Ross-on-Wye (GB)

(21) Appl. No.: 13/513,759

(22) PCT Filed: Dec. 6, 2010
(86) PCT No.: PCT/GB10/02239

§ 371 Date: Sep. 11, 2012

(30) Foreign Application Priority Data
Dec. 4, 2009 (GB) 0921227.5

(51) Int. Cl. H04R 1/02; H04R 5/02

(52) U.S. Cl. 381/300; 381/386

(57) ABSTRACT

A personal audio device comprises a first speaker housing (10) having a speaker (12) associated therewith, and a second speaker housing (18) having a speaker (20) associated therewith, wherein the first and second speaker housings (10, 18) are provided with wireless communication means whereby an audio signal can be transmitted from the first speaker housing (10) to the second speaker housing (18) for output by the speaker (20) associated with the second speaker housing (18).

This invention relates to personal audio equipment, and in particular to personal audio equipment of the type in which a user wears a headset or earphones in order to hear an audio output. Although suitable for use in listening to music or other recorded audio signals, the equipment may be used in other applications, for example as part of a hands-free kit or device to allow the use of a mobile telephone device in a hands-free mode.

A wide range of personal audio devices of this general type are known. For example, personal stereo devices whereby a user can listen to pre-recorded music through earphones are well known, the audio signals being stored upon, for example, a cassette or CD, or increasingly commonly as a data file stored in mp3, or similar, format. The devices may be used for listening to other audio inputs, for example transmitted radio signals, or the output from, for example, a mobile telephone device to allow the mobile telephone device to be operated in a hands-free mode. Where the personal audio device is of the type in which the output thereof is in stereo form, having separate output channels being output via separate speakers associated with each of the users ears, or where the device has separate speakers for each of the users ears, but the outputs of the separate speakers are identical, then is it necessary to have a wired connection to each of the speakers. For example, separate cables may pass from an audio module of the device to each of the speakers. However, arrangements are also known in which a cable passes from the audio module to one of the speakers, or a housing associated therewith, and another cable passes from that speaker or associated housing to the other speaker or an associated housing. Clearly, having cables passing in this manner can be inconvenient, and it is desirable to provide a device in which the number of cables are reduced.

Personal audio devices which take the form of modules or housings designed to be mounted upon or formed integrally with a spectacles frame are known. With such devices, where the audio module is provided in one of the housings, it is necessary to provide a wired connection between the housings to allow the speaker associated with the other of the housings to receive an output signal. For example, it is known to mount cables or the like within the spectacles frame to conduct the output signals between the housings. The provision of cables or other wired connections between the housings places design constraints upon the design of the spectacles, and it is desirable to remove or lessen these constraints.

According to a first aspect of the invention there is provided a personal audio device comprising a first speaker housing having a speaker associated therewith, and a second speaker housing having a speaker associated therewith, wherein the first and second speaker housings are provided with wireless communication means whereby an audio signal can be transmitted from the first speaker housing to the second speaker housing for output by the speaker associated with the second speaker housing.

Conveniently, the first and second speaker housings are each provided with separate, internal power supplies, for example in the form of rechargeable batteries.

The wireless communication means may comprise a low power microwave communications link. Alternatively, a low powered FM transmission or induction based arrangements may be used. A Bluetooth type transmission arrangement is currently envisaged.

The first and second speaker housings may be adapted to permit them to be mounted, preferably releasably, upon a spectacles frame, in use.

The first speaker housing conveniently incorporates an audio signal generation module, operable to output a signal to the speaker associated therewith, and a signal to the speaker associated with the second speaker housing via the wireless communication means. Preferably, the audio output achieved thereby is a stereo output.

The wireless communications link may permit the transmission of signals from the second speaker housing to the first speaker housing. In such an arrangement, the second speaker housing may contain a second audio signal generation module, for example, with different functionality. For example, one housing may incorporate an mp3 type player whilst the other is able to communicate with a mobile telephone device to permit the provision of a hands-free function. Where such two-way transmission is provided, different transmission frequencies or other suitable techniques may be used to avoid interference therebetween.

Alternatively, a remote signal generation module may be provided from which audio signals are transmitted to the first speaker housing. In such an arrangement, a wired link may be provided between the signal generation module and the first speaker housing. However, preferably, a wireless link, for example a microwave communications link, eg a Bluetooth link, may be used. The remote signal generation module may comprise, for example, a mobile telephone device, a media file player such as an mp3 file player, or the like.

It will be appreciated that such an arrangement is advantageous in that there is no need to provide a wired connection between the speaker housings, thus design constraints, and the inconvenience of having cables running to the speaker housings, is removed.

If desired, particularly where an FM radio link is used to provide the wireless communications means and the housings are attachable to a spectacles frame, the temples of the spectacles frame conveniently each incorporate or form an antenna, mounting of the housings to the spectacles frame connecting the circuits of the housing to the antenna.

The invention also relates to a personal audio device comprising a first speaker housing having a speaker associated therewith, a second speaker housing having a speaker associated therewith, an audio module, and wireless communication means providing wireless communications links between the audio module and the first and second speaker housings. Many of the features set out above are equally applicable to such an arrangement.

The invention will further be described, by way of example, with reference to the accompanying drawings, in which:

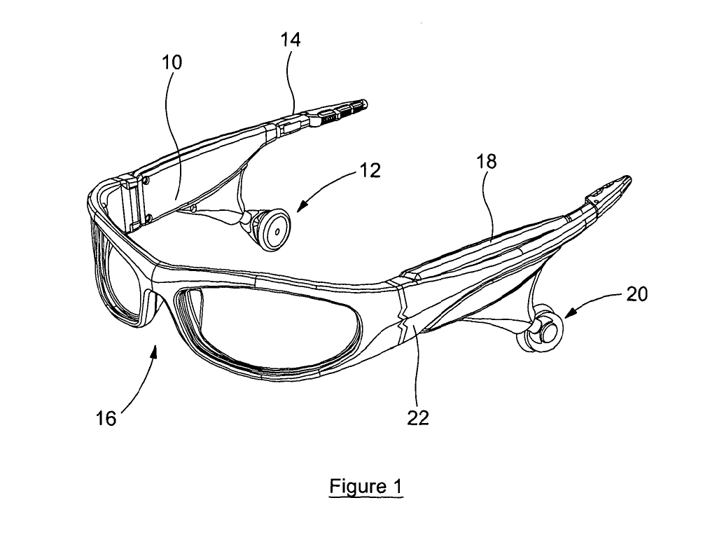

FIG. 1 is a perspective view illustrating a personal audio device in accordance with one embodiment of the invention;

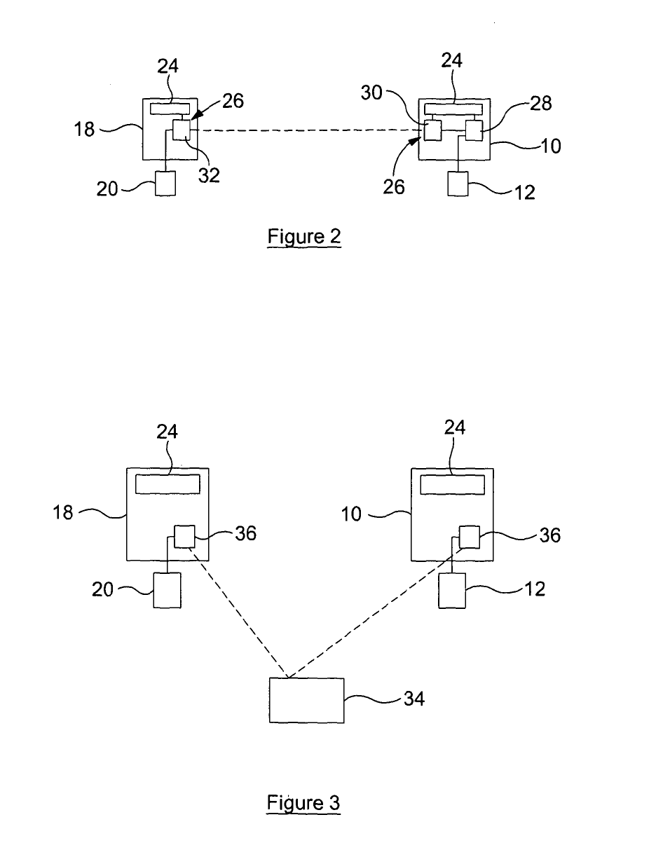

FIG. 2 is a diagram illustrating the operation of the device of FIG. 1;

FIG. 3 is a view similar to FIG. 2 illustrating an alternative arrangement; and

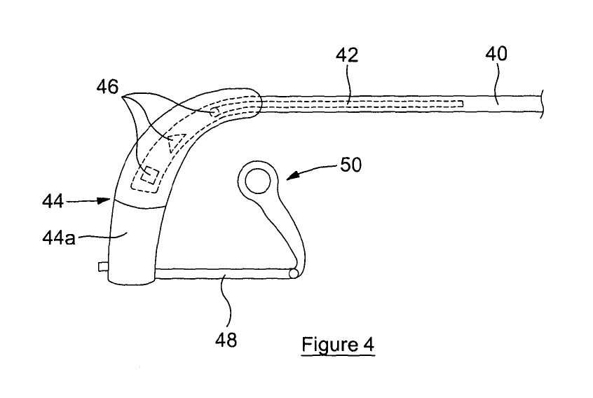

FIG. 4 illustrates an alternative embodiment.

Referring firstly to FIGS. 1 and 2, there is illustrated a personal audio device comprising a first speaker housing 10 having a speaker 12 associated therewith. The first speaker housing 10 is adapted to be realeasably mounted upon a temple 14 of a spectacles frame 16. The device further comprises a second speaker housing 18 having a speaker 20 associated therewith, the second speaker housing 18 being adapted to be releasably mounted upon the other temple 22 of the spectacles frame 16. The manner in which the housings 10, 18 are secured to the spectacles frame 16 is not a particular importance to this invention and will not be described in detail herein, save to say that a man skilled in the art would be aware of many suitable techniques for securing the speaker housings 10, 18 to the frame 16.

Once fitted to the spectacles frame 16, it will be appreciated that when the spectacles frame 16 is worn by a user in the usual manner, the speakers 12, 20 will be positioned adjacent the users ears. Depending upon the nature of the speakers 12, 20, the speaker positions may be adjusted, for example to introduce the speakers 12, 20 into appropriate in-ear positions, or alternatively they may be supported adjacent the users ears. In either case, the designs of the speaker housings 10, 18 are such as to permit appropriate adjustment of the speaker positions, and to provide appropriate support for the speakers.

Each speaker housing 10, 18 contains an internal rechargeable battery 24, for example rechargeable by locating the housing within a suitable docking station or by making a wired connection thereto when not being worn, the battery being arranged to power internal circuits 26 provided in the housings 10, 18. The circuits 26 of the first speaker housing 10 include a signal generating and control circuit 28 whereby an audio signal is generated. For example, the circuit 28 may take the form of an audio media file player, for example an mp3 file player, and appropriate control means to permit control over the operation thereof. The control means permits control over, for example, track selection, playback volume, etc. The output of the circuit 28 is supplied to the speaker 12 associated with the first speaker housing 10 and is also supplied to a wireless communications circuit 30 whereby the signal, or at least part thereof, is transmitted for reception by a wireless communications circuit 32 of the second speaker housing 18. The output from the circuit 32 is supplied to the speaker 20 associated with the second speaker housing 18. If the circuit 28 is of the type arranged to output a stereo audio signal, then is will be appreciated that one output channel may be applied to one of the speakers, the other channel being transmitted for output by the other of the speakers.

The wireless communications link established by the circuits 30, 32 may take a range of forms, for example it may comprise a microwave, for example Bluetooth, transmission or an FM radio transmission. In either case, as the signal need only be transmitted over a short distance, requiring transmission from a housing close to one of the users ears to housing located close to the other of the users ears, it will be appreciated that the transmission need only be a low powered transmission, which is beneficial as it will permit smaller batteries to be used, or permit recharging of the batteries less frequently. If desired, the signals may be encrypted or encoded in such a manner as to enhance security and reduce the risk of cross-talk or interference between similar devices. Encryption may be particularly desirable where used in a hands-free kit for a mobile telephone device as it reduces the risk of unauthorised interception. However, there may also be circumstances where such encryption is not required.

It will be appreciated that the personal audio device described hereinbefore is advantageous in that, in use, no wired connections are provided between the speaker housings, thereby avoiding the problems associated with trailing cables, and reducing the design constraints on the designs of, for example, the spectacles frames as there is no need to incorporate or support a cable extending between the temples thereof.

The spectacles frame may be designed to carry, for example, tinted or coloured lenses, for example to serve as sunglasses, and/or may carry prescription lenses if desired. The lenses could, in some circumstances, be removable or replaceable to allow the user to alter the appearance of the spectacles, if desired. For example, the user may be able to substitute the lenses to change the lens colour or to switch between a full face spectacles design and a half-face spectacles design.

Although in FIGS. 1 and 2 the circuit 28 generating the audio signal is located within the first speaker housing 10, this need not always be the case and the circuit 28 could be located in a remote audio signal generation module, for example in the form of a separate audio media file player or in a mobile telephone device. In such an arrangement, a wireless communications link may be provided between the signal generation module and the first speaker housing 10, the circuit 28 then taking the form of a wireless communications receiver circuit whereby the audio signal is received by the first speaker housing 10 and is supplied to the speaker 12 and to the circuit 30 for transmission to the second speaker housing 18.

Of course, arrangements are also possible in which, during some operating modes, an internal audio signal generation circuit is used, and in other operating modes, a remote audio signal generation module is used.

If desired, the circuits 30, 32 may be configured in such a manner as to permit two-way communication between the housings 10, 18. In such an arrangement, the second speaker housing 18 may be provided with a second signal generating module, perhaps with different functionality to that of the first speaker housing 10, to allow operation with the audio module of the second speaker housing 18 supplying an audio signal to both speakers, the transmission of the signal to the speaker 12 being via the wireless communications link. Such an arrangement may permit an increase in the overall functionality of the device in a relatively simple and convenient form. Any appropriate technique may be provided to ensure that the signals do not interfere with one another to an unacceptable extent.

FIG. 3 illustrates, diagrammatically, a modification in which, rather than transmit signals between the speaker housings 10, 18, signals are transmitted separately from a remote audio generation module 34 to receiving circuits 36 provided in each speaker housing 10, 18. Again, in such an arrangement, the provision of cables between the speaker housings is avoided, and so the inconvenience and design constraints associated there with are avoided.

FIG. 4 illustrates an arrangement the operation of which is very similar to that described hereinbefore, and so only the significant differences are described herein. In the arrangement of FIG. 4, an FM radio transmission is used to provide the wireless communications link between the housings. Rather than incorporate an internal FM antenna, each temple 40 of the spectacles frame conveniently incorporates such an antenna 42. Transmission and/or receive circuits within each housing 44 are connectable to the respective antenna 42 when the housings 44 are secured to the temples 40. In the arrangement illustrated, the temple 40 is provided with a series of openings 46 with which features provided within the housings 44 are adapted to cooperate to mechanically secure the housings 44 to the temples 40. For example, the housings 44 may be of resilient form, at least in part, squeezing of the housings 44 allowing the said features to be fitted into or removed from the respective openings 46. One of the openings 46 provides access to the antenna 42, and a pin (for example of spring loaded form) provided within the housing 44 introduced into that opening 46 provides electrical contact with the antenna 42.

The housings 44 could be of a shape and style similar to that shown in FIG. 1. However, it is currently envisaged that they may be adapted to extend, in use, behind and beneath the users ear, a forwardly extending projection 48 supporting a speaker 50 in or adjacent the users ear canal, in use. In such an arrangement, a lower part 44a of the housing 44 may be rotatable to allow the projection 48 to extend rearwardly. With many users, such movement will allow the projection 48 and speaker 50 to be hidden, for example by the users hair, and so allows the device to be positioned discretely when not in use, without requiring it to be removed from the spectacles frame if so desired.

It will be appreciated that a wide range of modifications and alterations may be made to the arrangement described hereinbefore without departing from the scope of the invention.

1. A personal audio device comprising a first speaker housing having a speaker associated therewith, and a second speaker housing having a speaker associated therewith, wherein the first and second speaker housings are provided with wireless communication means whereby an audio signal can be transmitted from the first speaker housing to the second speaker housing for output by the speaker associated with the second speaker housing.

2. A device according to claim 1, wherein the first and second speaker housings are each provided with separate, internal power supplies.

3. A device according to claim 2, wherein the internal power supplies comprise rechargeable batteries.

4. A device according to any of the preceding claims, wherein the wireless communication means comprises a low power microwave communications link.

5. A device according to any of claims 1 to 3, wherein the wireless communication means is in the form of a low powered FM transmission.

6. A device according to any of the preceding claims, wherein the first and second speaker housings are adapted to permit them to be mounted upon a spectacles frame, in use.

7. A device according to claim 6, wherein the speaker housings are releasably mounted to the spectacles frame.

8. A device according to any of the preceding claims, wherein the first speaker housing incorporates an audio signal generation module, operable to output a signal to the speaker associated therewith, and a signal to the speaker associated with the second speaker housing via the wireless communication means.

9. A device according to claim 8, wherein the audio output is a stereo output.

10. A device according to any of the preceding claims, wherein a remote signal generation module is provided from which audio signals are transmitted to the first speaker housing.

11. A device according to any of the preceding claims, wherein an FM radio link is used to provide the wireless communications means and the housings are attachable to a spectacles frame, the temples of the spectacles frame each incorporating or forming an antenna, mounting of the housings to the spectacles frame connecting the circuits of the housing to the antenna.

12. A device according to claim 11, wherein each temple is provided with openings into which projections provided on or associated with the housing can be fitted to secure the housing to the temple.

13. A device according to claim 12, wherein one of the projections is used to provide an electrical connection between the circuits of the housing and the antenna.

14. A device according to claim 13 wherein that projection comprises a resilient pin.

15. A device according to any of the preceding claims, wherein the housing is adapted to extend behind the users ear, at least in part, in use.

16. A device according to any of the preceding claims, wherein the housing includes a moveable part, allowing the speaker to me moved to an unobtrusive position.

17. A personal audio device comprising a first speaker housing having a speaker associated therewith, a second speaker housing having a speaker associated therewith, an audio module, and wireless communication means providing wireless communications links between the audio module and the first and second speaker housings.
